(19) United States
(12) Patent Application Publication
(10) Pub. No.: US 2002/0032496 A1
(43) Pub. Date: Mar. 14, 2002

(54) Transport device

(76) Inventors: Gerd Bruckner, Boxdorf (DE); Walter Melojer, Dresden (DE); Gerhard Rauter, Dresden (DE)

Correspondence Address: LERNER AND GREENBERG, P.A., Post Office Box 2480, Hollywood, FL, 33022-2480, US

(21) Appl. No.: 09/901,542

(22) Filed: Jul. 9, 2001

Related U.S. Application Data
(63) Continuation of application No. PCT/DE00/00044, filed on Jan. 5, 2000.

(30) Foreign Application Priority Data
Jan. 8, 1999 (DE) 199 00 461.7

(51) Int. Cl. G06F 19/00

(52) U.S. Cl. 700/112; 700/114; 700/111; 700/124; 700/214; 700/218

(57) ABSTRACT

A transport device in which two drive rollers are coupled with and face one another is described. Both drive rollers exert a uniform driving force on the webs of a container so that the container is transported linearly and without jolts. The transport device for transporting containers with at least two parallel webs contains at least two parallel rows of rollers on which the webs can run. At least one group of drive rollers for transmitting a driving force to the webs is provided. The drive rollers contain one primary drive roller and at least one secondary drive roller. The drive rollers are integrated into one row of rollers and the primary drive roller is driven by a motor. The drive rollers are coupled with one another in such a manner that the primary drive roller drives the secondary drive roller.

### CROSS-REFERENCE TO RELATED APPLICATION

This application is a continuation of copending International Application PCT/DE00/00044, filed Jan. 5, 2000, which designated the United States.

### BACKGROUND OF THE INVENTION

### Field of the Invention

In processing and shipping of goods or semi-finished products, the question often arises of transport over a short distance, for example from one processing station to the next or to the storage area. In many cases, such a transport is effected by conveyor belts or systems of transport rollers on which transport containers or the goods themselves are directly transported. For many goods, such as for example wafers for semiconductor production, the transport containers, known as carriers, must have shapes determined by production, resulting in a corresponding adaptation of the transport devices.

In the following, such a transport device known from the prior art is presented with exemplary reference to the transport of wafer carriers. However, it is to be understood that such transport devices can also be used with other containers, should a corresponding task arise.

The transport containers for semiconductor wafers are equipped laterally at the bottom with two webs that run in parallel, which are used for transport in the transport device. The transport containers project further downward between the webs. This is taken into account in the known transport device in that the webs are guided on short running rollers attached to lateral bearers disposed in parallel at a distance from one another. The lateral bearers are connected to form a unit by use of distance bolts. An open space, into which the transport container extends, is provided between the lateral bearers. For this reason, the running rollers are not executed continuously from one lateral bearer to the other, but rather as flat disks that extend only slightly into the space between the lateral bearers.

On one of the lateral bearers, after a given number of running rollers there follows a drive roller. It is for example typical that a drive roller is integrated after every four running rollers. The drive rollers are rotated by motors.

So that the drive rollers can exert a driving force on the transport containers for further transportation, they must extend beyond an imagined line formed by the running rollers at their circumference on the side facing the webs of the transport container, i.e., upward.

In this way, every time a transport container comes into contact with the drive roller attached on one side, there arises a laterally rough, jerky motion which, through its continuousness, results in a vibration of the transport container and of the wafers located therein. This vibration results in an increased production of particles, and therefore to a reduction in the quality of the wafers.

It is therefore desirable to create a transport device in which the transport containers are guided in a protective fashion over the rollers, without receiving the disadvantageous lateral forces.

### SUMMARY OF THE INVENTION

It is accordingly an object of the invention to provide a transport device that overcomes the above-mentioned disadvantages of the prior art devices of this general type.

With the foregoing and other objects in view there is provided, in accordance with the invention, a transport device for transporting containers each having at least two webs that run in parallel. The transport device includes at least two parallel rows of a series of running rollers on which the webs of the containers can run. At least one group of drive rollers transmitting a drive force to the webs of the containers is provided. The drive rollers include a primary drive roller and at least one secondary drive roller, each of the drive rollers is integrated in one of the rows of the series of the running rollers. A motor driving the primary drive roller is provided. The drive rollers are coupled with one another in such a way that the primary drive roller drives the secondary drive roller. Lateral bearers are disposed in parallel and at a distance from one another, the running rollers and the drive rollers are attached to the lateral bearers.

In one aspect, the invention is directed to a transport device in which a second drive roller is concomitantly driven.

In a further aspect, the invention is directed to a transport device in which two drive rollers coupled with one another are situated opposite one another, both exerting a uniform drive force on the webs of the container, so that the container is transported in a linear fashion without jerks.

In still another aspect, the invention is directed to a transport device in which a force coupling of the two drive rollers situated opposite one another takes place in such a way that there remains between them an open space into which the transport container can extend.

Correspondingly, the invention is directed to a transport device for containers having at least two webs that run in parallel, the transport device includes at least two parallel rows of running rollers on which the webs can run. The transport device is characterized by at least one group of the drive rollers for the transmission of a drive force to the webs, including a primary drive roller and at least one secondary drive roller. Each of the drive rollers is integrated into a series of drive rollers, the primary drive roller being driveable, or driven, by a motor, and the drive rollers of the least one group of drive rollers being coupled with one another in such a way that the primary drive roller drives, or can drive, the at least one secondary drive roller.

Preferably, the drive rollers of the at least one group of drive rollers are coupled with one another via a force transmission shaft.

For example, lateral bearers at a distance from one another are provided on which the series of running rollers and the drive rollers are situated. The drive rollers of the at least one group of drive rollers can be mounted in the lateral bearers so as to stand opposite one another.

In relation to the webs of the containers transported on them, the running rollers preferably form, at their circumference facing the container, an imagined line, whereby the drive rollers extend past the imagined line so that they can transmit the drive force to the webs. Additional drive wheels can be disposed on the drive rollers for the transmission of the drive force to the webs. The drive wheels, or also the drive rollers directly, can be coated with layers of rubber, or can be provided with some other measure in order to improve the friction between them and the webs.

The transmission of force between the drive rollers can be effected in that at least two transmission wheels are disposed on the force transmission shaft, whereby one of the transmission wheels stands in contact with the primary drive roller and transmits the rotation thereof to the force transmission shaft. A second transmission wheel transmits the rotation of the force transmission shaft to the at least one secondary drive roller. Here as well, the transmission of force can again be supported by rubber coatings that are attached to the drive rollers/wheels and to the transmission wheels.

In accordance with an added feature of the invention, the running rollers rotate freely in the lateral bearers. In accordance with another feature of the invention, drive wheels are disposed on a circumference of the drive rollers. The drive wheels and the drive rollers are each coated on a circumference with rubber coatings, and a transmission of force between the drive rollers and the transmission wheels takes place through friction of the rubber coatings of the drive wheels and of the transmission wheels.

In accordance with an additional feature of the invention, the secondary drive roller is one of a plurality of secondary drive rollers each disposed spaced apart within one of the rows of the series of the running rollers.

In accordance with a further feature of the invention, the at least one group of drive rollers is one of a plurality of groups of drive rollers and the motor drives the plurality of groups of drive rollers.

In accordance with a concomitant feature of the invention, the at least one group of drive rollers is one of a plurality of groups integrated into the rows of the series of the running rollers. The plurality of groups of drive rollers are spaced from one another in such a way that at all times at least one of the plurality of groups of drive rollers can drive the webs of the containers.

Other features which are considered as characteristic for the invention are set forth in the appended claims.

Although the invention is illustrated and described herein as embodied in a transport device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side sectional view of a transport device with a cross-section through lateral bearers according to the invention; and

FIG. 2 is a perspective view of a specific embodiment of the invention, in which a lateral bearer is shown.

### DESCRIPTION OF THE PREFERRED EMBODIMENTS

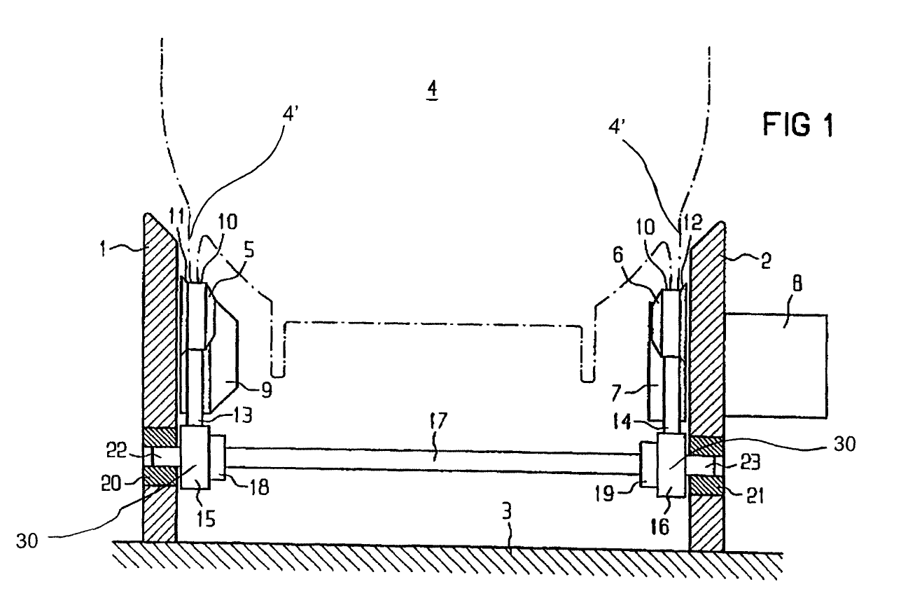

In all the figures of the drawing, sub-features and integral parts that correspond to one another bear the same reference symbol in each case. Referring now to the figures of the drawing in detail and first, particularly, to FIG. 1 thereof, there is shown a transport device which includes two lateral guides in which various rollers are mounted. In FIG. 1, two lateral bearers 1, 2 are shown that are used for this purpose and at the same time hold the device far enough from the ground or a base 3 and below that a transport container 4, here a wafer carrier, can run on the rollers unproblematically, without its protruding region becoming caught on the ground 3 below or on other parts of the device.

The lateral bearers 1, 2 can be connected with the ground below or can be held at a defined distance from one another using spacing bolts.

Running rollers 5, 6 are disposed on the mutually facing surfaces of the lateral bearers 1, 2. The rollers 5, 6 being mounted in the lateral bearers 1, 2 for example with ball bearings. The running rollers 5, 6 rotate freely in their bearings when a web 4′of a transport container 4 runs over them. In FIG. 1, the running rollers 5, 6 have a rubber coating that improves the adhesion between the rollers 5, 6 and the webs, running thereon, of the transport containers 4. In addition, the rollers 5, 6 are provided with chamfers 11, 12 that extend to the lateral bearers 1, 2 externally, in order to enable a guiding of the webs.

A primary drive roller 7, driven by a motor 8, is likewise housed in the lateral bearer 2.

On the other lateral bearer 1, a secondary drive roller 9 is disposed that is inventively coupled with the primary drive roller 7 in order to ensure a transmission of force from both drive rollers 7, 9. In FIG. 1, the coupling is achieved using a force transmission shaft 17 that receives a force of the primary drive roller 7 by a transmission wheel 16 attached to the force transmission shaft 17 and conveys the force to the secondary drive roller 9 via a further transmission wheel 15. Here the transmission wheels 15, 16 are placed on shaft mounts 18, 19 that are used for the connection of the transmission wheels 15, 16 with the shaft 17. However, other ways, standard in the prior art, of fastening the wheels 15, 16 to the shaft 17 are also possible. The force transmission shaft 17 is mounted with its end regions being two bearing shafts 22 and 23, in two bearings 21, 22 that are situated in the lateral bearers 1,2.

The coupling shown in FIG. 1 is a mechanical one. Assuming equal sizes of the drive rollers 7, 9 and of the transmission wheels 15, 16, the coupling ensures that the at least two drive rollers 7, 9 move with the same circumferential speed, and thus that a more uniform transport of the transport container 4 is possible than in the prior art. However, it is also possible to execute the coupling in another way, for example electrically. In such a case, a sensor can be attached to the primary drive roller 7 that determines the speed thereof and forwards the information to a control unit that, by use of a second motor, sets the speed of secondary drive roller 9 always to the same value as the speed of the first drive roller 7.

In the specific embodiment shown in FIG. 1, the two drive rollers 7, 9 are provided with drive wheels 13, 14 that enlarge the circumference of the central cylinders of the drive rollers 7, 9 and the actual contact surface to transmission wheels 15, 16.

All contact surfaces of the drive rollers 7, 9, the drive wheels 13, 14, and the transmission wheels 15, 16 can be provided with a rubber surface 30 in order to improve the friction between them, or between them and the webs of the transport containers 4.

However, it is also conceivable that the transmission of force from/to the drive rollers/transmission wheels take place through toothed wheels, whereby, for this purpose, on the drive rollers 7, 9, in addition to the drive wheels 13, 14 on which the webs 4′ of the transport containers 4 run, toothed wheels are disposed on the central cylinder that engage with the transmission wheels 15, 16, which are fashioned as toothed wheels.

According to the invention, at least one group of drive rollers is provided that is made up of at least two drive rollers, the primary drive roller 7 driven by the motor 8 and the secondary drive roller 9 coupled therewith. However, it is equally possible to provide more than one secondary drive roller 9 in a group of drive rollers, all of which are coupled with primary drive roller 7. Such a system enables for example transport of wider transport containers 4, in the case of which it is desirable for static reasons to provide them with additional support in their center.

A plurality of the primary drive rollers 7 that belong to different groups of the drive rollers 7, 9 can also be driven by a common motor 8. This specific embodiment is suitable above all for the case of lighter transport containers, in order to lower equipment costs. Such a drive can for example be carried out by toothed wheels in place of the motors 8 and a toothed chain that leads around all the toothed wheels and the common drive motor.

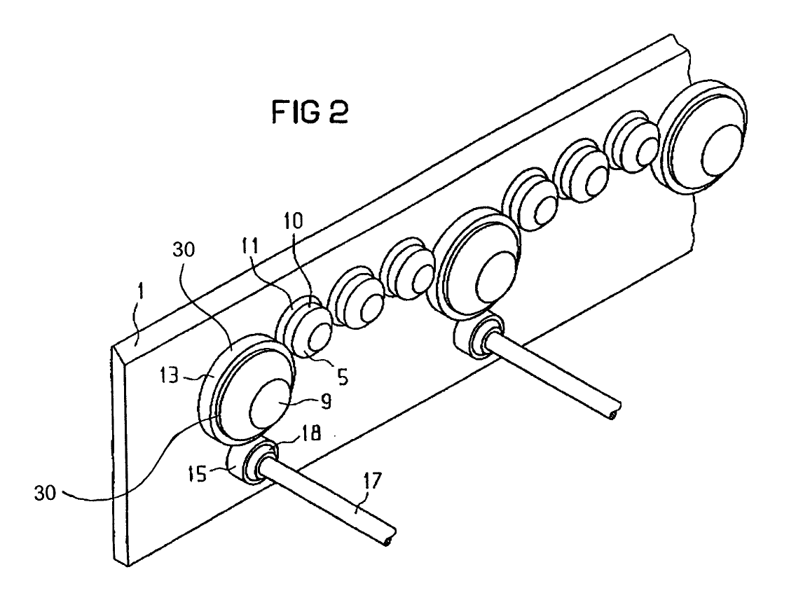

FIG. 2 shows a perspective view of the lateral bearer 1 with the running rollers 5 and the drive rollers 9. Here the lateral bearer 1 is shown as example, on which secondary the drive rollers 9 are disposed. As shown, here the drive roller 9 follows every three running rollers 5. However, it is also possible to situate more or fewer running rollers between the individual drive rollers 7, 9. In any case, the distance between the drive rollers 7, 9 must be dimensioned such that a group of the drive rollers 7, 9 can convey the transport container 4 up to the point of a secure contact with the next group of the drive rollers 7, 9. The distance is preferably selected such that at any point in time at least one group of the drive rollers 7, 9 can drive the webs 4′ on the containers 4.

In FIG. 2, the running rollers 5, 6 are shown with a close spacing to one another and to the drive rollers 9. However, it is also possible to enlarge the spacing, as long as the reliable transport of the containers 4 remains ensured.

It is also possible to situate the lateral bearers and rollers in such a way that a curved path is possible. For this purpose, the corresponding elements must be disposed in such a way that the container 4 cannot for example become caught on the lateral bearers. Since when traveling curved paths the outer side of a container must move faster than the inner side, it is additionally necessary to cause the drive wheels to run at different speeds. This can for example be achieved by constructing the two transmission wheels with different sizes, in order to achieve such a transmission.

The present invention solves the problem of non-uniform transport movements that occurred in previous transport devices. The invention achieves an exact, rectilinear motion of the transport container 4.

We claim:

1. A transport device for transporting containers each having at least two webs that run in parallel, the transport device comprising:
at least two parallel rows of a series of running rollers on which the webs of the containers can run;
at least one group of drive rollers transmitting a drive force to the webs of the containers, said drive rollers including a primary drive roller and at least one secondary drive roller, each of said drive rollers integrated in one of said rows of said series of said running rollers;
a motor driving said primary drive roller, and said drive rollers are coupled with one another in such a way that said primary drive roller drives said secondary drive roller; and
lateral bearers disposed in parallel and at a distance from one another, said running rollers and said drive rollers are attached to said lateral bearers.

2. The transport device according to claim 1, including a force transmission shaft coupling said drive rollers to one another.

3. The transport device according to claim 1, wherein said running rollers rotate freely in said lateral bearers.

4. The transport device according to claim 1, wherein said drive rollers are mounted in said lateral bearers so as to stand opposite one another.

5. The transport device according to claim 1, wherein in relation to the webs of the containers that can be transported on said running rollers, said running rollers form, at their circumference facing the containers, an imagined line, and in that said drive rollers extend past the imagined line in order to enable a transmission of the drive force to the webs.

6. The transport device according to claim 1, including drive wheels for a transmission of the drive force to the webs are disposed around said drive rollers.

7. The transport device according to claim 6, including rubber coatings, for assisting in the transmission of the drive force to the webs, are disposed on a circumference of said drive wheels.

8. The transport device according to claim 2, including two transmission wheels disposed on said force transmission shaft, a first of said transmission wheels stands in contact with said primary drive roller and transmits a rotation thereof to said force transmission shaft, and a second of said transmission wheels transmits the rotation of said force transmission shaft to said secondary drive roller.

9. The transport device according to claim 8, wherein said transmission wheels and said drive rollers each have rubber coatings disposed on a circumference thereof and a transmission of force between said drive rollers and said transmission wheels takes place through friction of said rubber coatings.

10. The transport device according to claim 8, including drive wheels disposed on a circumference of said drive rollers, said drive wheels and said drive rollers are each coated on a circumference with rubber coatings, and a transmission of force between said drive rollers and said transmission wheels takes place through friction of said rubber coatings of said drive wheels and of said transmission wheels.

11. The transport device according to claim 1, wherein said secondary drive roller is one of a plurality of secondary drive rollers each disposed spaced apart within one of said rows of said series of said running rollers.

12. The transport device according to claim 1, wherein said at least one group of drive rollers is one of a plurality of groups of drive rollers and said motor drives said plurality of groups of drive rollers.

13. The transport device according to claim 1, wherein said at least one group of drive rollers is one of a plurality of groups integrated into said rows of said series of said running rollers, said plurality of groups of drive rollers are spaced from one another in such a way that at all times at least one of said plurality of groups of drive rollers can drive the webs of the containers.

14. A method for transporting semiconductor wafers, which comprises the steps of:
providing a transport device for transporting containers each having at least two webs that run in parallel, the transport device includes:
at least two parallel rows of a series of running rollers on which the webs of the containers can run;
at least one group of drive rollers transmitting a drive force to the webs of the containers, the drive rollers including a primary drive roller and at least one secondary drive roller, each of the drive rollers integrated in one of the rows of the series of the running rollers;
a motor driving the primary drive roller, and the drive rollers are coupled with another in such a way that the primary drive roller drives the secondary drive roller; and
lateral bearers disposed in parallel and at a distance from one another, the running rollers and the drive rollers are attached to the lateral bearers; and
transporting the semiconductor wafers in the drive containers.
